(19) United States
(12) Patent Application Publication
(10) Pub. No.: US 2008/0010294 A1
(43) Pub. Date: Jan. 10, 2008

(54) Systems and methods for subscribing to updates of user-assigned keywords

(76) Inventors: Kenneth Norton, San Carols, CA (US); Chung-Man Tam, San Francisco, CA (US); Zhichen Xu, San Jose, CA (US)

Correspondence Address: DREIER LLP, 499 PARK AVE, NEW YORK, NY, 10022, US

(21) Appl. No.: 11/586,434

(22) Filed: Oct. 25, 2006

Related U.S. Application Data
(60) Provisional application No. 60/730,542, filed on Oct. 25, 2005.

(51) Int. Cl. G06F 17/30

(52) U.S. Cl. 707/10; 707/E17.001

(57) ABSTRACT

A method for notifying a subscribing user when an annotating user tags a content item with a keyword includes: providing an interface operable by the subscribing user to identify a subscription keyword and/or an annotating user; defining an RSS feed corresponding to the keyword and the annotating user; configuring an annotation server to update the RSS feed in the event that the annotating user tags a content item with the subscription keyword; and providing the subscribing user with access to Corresponding systems are also described.

### PRIORITY CLAIM

This application claims the benefit of U.S. Provisional Application Ser. No. 60/730,542, filed on Oct. 10, 2005, entitled “Systems and Methods For Subscribing To Updates Of User-Assigned Keywords” and is incorporated by reference in its entirety.

### CROSS-REFERENCES TO RELATED APPLICATIONS

The present disclosure is related to the following commonly-assigned co-pending U.S. patent applications: application Ser. No. 11/081,860, filed Mar. 15, 2005, entitled “Search System and Methods With Integration of User Annotations”; and application Ser. No. 11/082,202, filed Mar. 15, 2005, entitled “Search System and Methods With Integration of User Annotations From a Trust Network.” The respective disclosures of these applications are incorporated herein by reference for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The present invention relates in general to obtaining information from a corpus of documents, and in particular to information systems and methods that leverage annotations of documents provided by various users.

The World Wide Web (Web) provides a large collection of interlinked information sources (in various formats including texts, images, and media content) relating to virtually every subject imaginable. As the Web has grown, the ability of users to search this collection and identify content relevant to a particular subject has become increasingly important, and a number of search service providers now exist to meet this need. Conventional search services rely on indexing the content of various Web pages. A querying user submits a search query containing one or more search terms; the search terms are matched against terms in an index of Web content; and a list of results is generated based at least in part on how well the content of particular pages matches the search terms. Simply matching terms, however, turns out not to be a reliable way of providing content relevant to the user's actual interest.

More recently, efforts have been made to improve on conventional search. One area under development is the “recommender system,” in which users who visit a particular Web page or site can evaluate it and (in varying degrees) make their evaluations public. User evaluations can be used to assist subsequent searchers. For instance, some recommender systems allow users to “tag” the content item with keywords or labels that describe the subject matter of the item; the tags assigned by various users can influence the system's response to subsequent queries by that user and/or other users. Thus, recommender systems transcend the computer's ability to identify matching terms by adding a component of human identification of the actual subject matter of various pages or sites.

As users participate over time, a recommender system can develop a virtual catalog of content organized around keywords selected by users. Content is added to the virtual catalog as users tag additional items. However, a user with an ongoing interest in some topic is generally not notified when new pages related to that topic are added to the virtual catalog; instead, the user has to periodically search the topic using the recommender system to see if anything new has been added.

It would, therefore, be desirable to provide improved ways for a user of interest to find out what content other users have tagged.

### BRIEF SUMMARY OF THE INVENTION

According to an aspect of the present invention, a method for notifying a subscribing user when an annotating user tags a content item with a keyword includes: providing an interface operable by the subscribing user to identify one or more subscription keywords and/or one or more annotating users; defining an RSS feed corresponding to the keyword and the annotating user; configuring an annotation server to update the RSS feed in the event that the annotating user tags a content item with the subscription keyword; and providing the subscribing user with access to the RSS feed.

The following detailed description together with the accompanying drawings will provide a better understanding of the nature and advantages of the present invention.

### BRIEF DESCRIPTION OF THE DRAWINGS

FIG. 1 illustrates a general overview of an information retrieval and communication network according to an embodiment of the present invention.

FIG. 2 illustrates another information retrieval and communication network according to an embodiment of the invention.

FIG. 3 illustrates an interface page via which a user can define subscriptions to content according to an embodiment of the present invention.

FIG. 4 is a flow diagram of a process for creating an RSS feed corresponding to subscription according to an embodiment of the present invention.

FIG. 5 is a flow diagram of a process for updating RSS feeds according to an embodiment of the present invention.

FIG. 6 illustrates an RSS feed for a keyword subscription as viewed by a user according to an embodiment of the present invention.

### DETAILED DESCRIPTION OF THE INVENTION

Embodiments of the present invention provide systems and methods allowing users to receive notification when other users annotate various documents (or other content items) found in a corpus such as the World Wide Web. As used herein, the term “annotation” refers generally to any descriptive and/or evaluative metadata related to a document from a corpus where the metadata is collected from a user and thereafter stored in association with an identifier of that user and an identifier of the subject document (i.e., the document to which the metadata relates). Annotations may include various fields of meta data, such as a rating (which may be favorable or unfavorable) of the page or site, one or more keywords or labels identifying a topic (or topics) of the page or site, a free-text description of the page or site, and/or other fields. An annotation is advantageously collected from a user of the corpus and stored in association with an identifier of the user who created the annotation and an identifier of the document (or other content item) to which it relates. Examples of annotations and processes for collecting annotations from users are described in above-referenced application Ser. No. 11/081,860. It is to be understood that the present invention is not limited to particular metadata or to particular techniques for collecting metadata.

In accordance with an embodiment of the present invention, a user can subscribe to a keyword. For instance, the user can request to be notified whenever another user annotates a content item with an annotation that includes the subscribed-to keyword. In some embodiments, the subscribing user receives notification of annotations created by any other user of the annotation system. In other embodiments, the subscribing user can specify particular users whose annotations are of interest. In still other embodiments, where users are related in trust networks, or the subscribing user can request to be notified if any of his or her trust network members creates an annotation that includes the subscribed-to keyword or label. The notifications are provided, e.g., via an RSS feed.

For purposes of illustration, the present description and drawings may make use of specific queries, search result pages, URLs, and/or Web pages. Such use is not meant to imply any opinion, endorsement, or disparagement of any actual Web page or site. Further, it is to be understood that the invention is not limited to particular examples illustrated herein.

### I. OVERVIEW

A. Network Implementation Overview

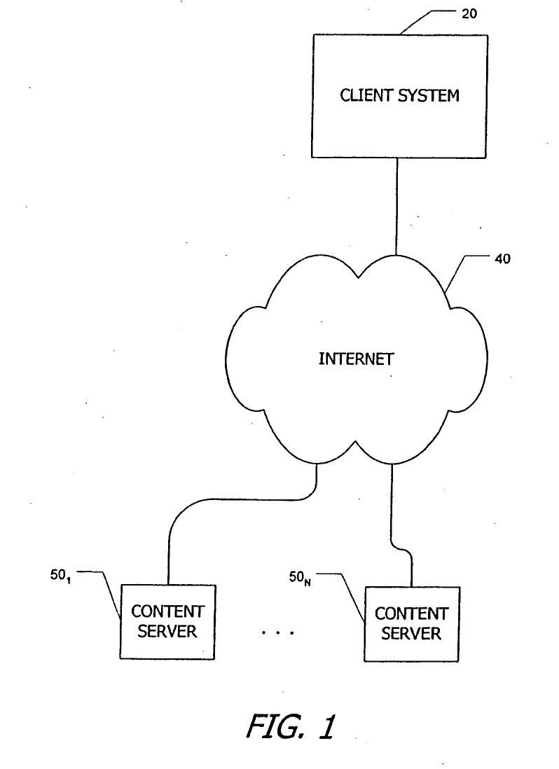

FIG. 1 illustrates a general overview of an information retrieval and communication network 10 including a client system 20 according to an embodiment of the present invention. In computer network 10, client system 20 is coupled through the Internet 40, or other communication network, e.g., over any local area network (LAN) or wide area network (WAN) connection, to any number of server systems 50₁ to 50_{N As} will be described herein, client system 20 is configured according to the present invention to communicate with any of server systems 50₁ to 50_{N}, e.g., to access, receive, retrieve and display media content and other information such as web pages.

Several elements in the system shown in FIG. 1 include conventional, well-known elements that need not be explained in detail here. For example, client system 20 could include a desktop personal computer, workstation, laptop, personal digital assistant (PDA), cell phone, or any W AP-enabled device or any other computing device capable of interfacing directly or indirectly to the Internet. Client system 20 typically runs a browsing program, such as Microsoft's Internet Explorer™ browser, Netscape Navigator™ browser, Mozilla™ browser, Opera™ browser, or a WAP-enabled browser in the case of a cell phone, PDA or other wireless device, or the like, allowing a user of client system 20 to access, process and view information and pages available to it from server systems 50₁, to 50_{N} over Internet 40. Client system 20 also typically includes one or more user interface devices 22, such as a keyboard, a mouse, touch screen, pen or the like, for interacting with a graphical user interface (GUI) provided by the browser on a display (e.g., monitor screen, LCD display, etc.), in conjunction with pages, forms and other information provided by server systems 50, to SON or other servers. The present invention is suitable for use with the Internet, which refers to a specific global internetwork of networks. However, it should be understood that other networks can be used instead of or in addition to the Internet, such as an intranet, an extranet, a virtual private network (VPN), a non-TCP/IP based network, any LAN or WAN or the like.

According to one embodiment, client system 20 and all of its components are operator configurable using an application including computer code run using a central processing unit such as an Intel Pentium™ processor, AMD Athlon™ processor, or the like or multiple processors. Computer code for operating and configuring client system 20 to communicate, process and display data and media content as described herein is preferably downloaded and stored on a hard disk, but the entire program code, or portions thereof, may also be stored in any other volatile or non-volatile memory medium or device as is well known, such as a ROM or RAM, or provided on any media capable of storing program code, such as a compact disk (CD) medium, a digital versatile disk (DVD) medium, a floppy disk, and the like.

Additionally, the entire program code, or portions thereof, may be transmitted and downloaded from a software source, e.g., from one of server systems 501 to SON to client system 20 over the Internet, or transmitted over any other network connection (e.g., extranet, VPN, LAN, or other conventional networks) using any communication medium and protocols (e.g., TCP/IP, HTTP, HTTPS, Ethernet, or other conventional media and protocols).

It should be appreciated that computer code for implementing aspects of the present invention can be C, C++, HTML, XML, Java, JavaScript, etc. code, or any other suitable scripting language (e.g., VBScript), or any other suitable programming language that can be executed on client system 20 or compiled to execute on client system 20. In some embodiments, no code is downloaded to client system 20, and needed code is executed by a server, or code already present at client system 20 is executed.

B. Search and Annotation System Overview

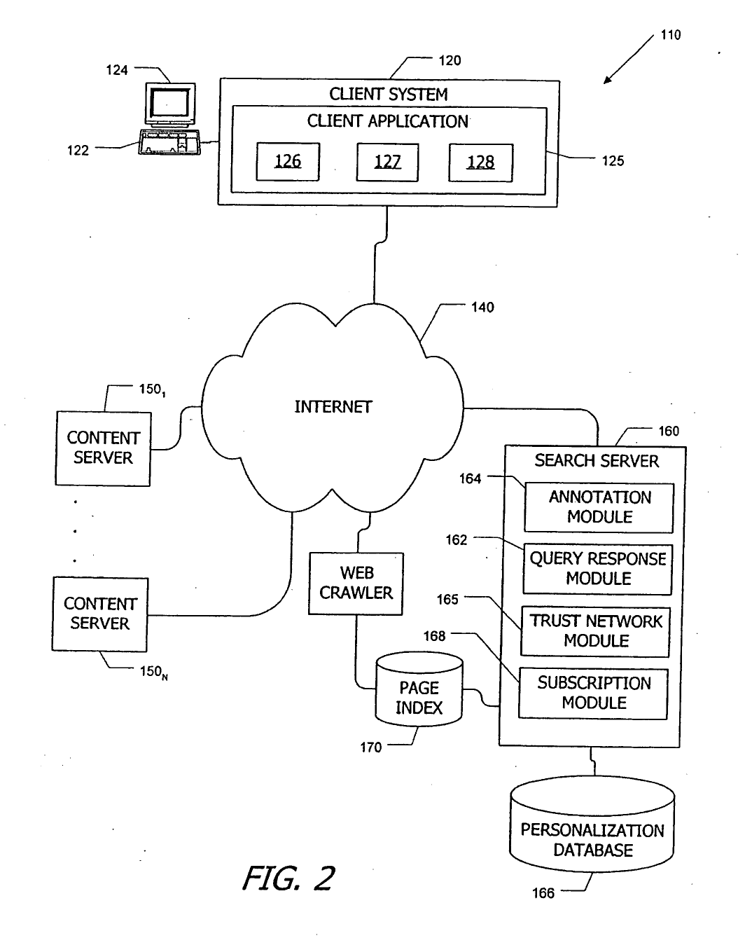

FIG. 2 illustrates another information retrieval and communication network 110 for communicating media content according to an embodiment of the invention. As shown, network 110 includes client system 120, one or more content server systems 150, and a search server system 160. In network 110, client system 120 is communicably coupled through Internet 140 or other communication network to server systems 150 and 160. As described above, client system 120 and its components are configured to communicate with server systems 150 and 160 and other server systems over the Internet 140 or other communication networks.

According to one embodiment, a client application (represented as module 125) executing on client system 120 includes instructions for controlling client system 120 and its components to communicate with server systems 150 and 160 and to process and display data content received therefrom. Client application 125 is preferably transmitted and downloaded to client system 120 from a software source such as a remote server system (e.g., server systems 150, server system 160 or other remote server system), although client application module 125 can be provided on any software storage medium such as a floppy disk, CD, DVD, etc., as described above. For example, in one aspect, client application module 125 may be provided over the internet 140 to client system 120 in an HTML wrapper including various controls such as, for example, embedded JavaScript or Active X controls, for manipulating data and rendering data in various objects, frames and windows.

Additionally, client application module 125 includes various software modules for processing data and media content, such as a specialized search module 126 for processing search requests and search result data, a user interface module 127 for rendering data and media content in text and data frames and active windows, e.g., browser windows and dialog boxes, and an application interface module 128 for interfacing and communicating with various applications executing on client 120. Examples of applications executing on client system 120 with which application interface module 128 is preferably configured to interface messaging (1M) applications, browser applications, document management applications and others. Further, user interface module 127 may include a browser, such as a default browser configured on client system 120 or a different browser.

According to one embodiment, search server system 160 is configured to provide search result data and media content to client system 120, and content server system 150 is configured to provide data and media content such as web pages to client system 120, for example, in response to links selected in search result pages provided by search server system 160. In some variations, search server system 160 returns content as well as, or instead of, links and/or other references to content. Search server system includes a query response module 162 configured to receive a query from a user and generate search result data therefore, a user annotation module 164 configured to manage user interaction with user-supplied annotation information, a trust network module 165 configured to manage a trust network for the user, and a subscription module 168 configured to manage subscriptions to keywords (or labels) for each user. Search server system 160 is communicably coupled to a personalization database 166 that stores data pertaining to specific users of search server system 160 and to a page index 170 that provides an index to the corpus to be searched (in some instances, the World Wide Web). Personalization database 166 and page index 170 may be implemented using generally conventional database technologies.

Trust network module 165 in one embodiment establishes a list of “friends” for each registered user of search server 160 and stores the lists in personalization database 166. The list of friends may be initialized automatically by trust network module 165 and edited by the user as described below, or it may be manually created. Based on the lists of friends established for various users, trust network module 165 defines, for each user, a trust network including that user's friends and, in some instances, friends of that user's friends and so on up to some limit. Examples of trust network module 165 and techniques for defining trust networks are described in above-referenced application Ser. No. 11/082,202.

Annotation module 164 in one embodiment interacts with personalization database 166 to store and manage user annotation data for various users of search server system 160. For instance, annotation data received from a user may be provided to annotation module 164 for storing in personalization database 166, and annotation module 164 may also respond to any requests for annotation data, including requests originating from query response module 162, other components of search server 160, and/or client 120. Various interfaces may be provided for user Various interfaces may be provided for user entry of annotation data. Examples are described in above-referenced application Ser. No. 11/081,860; any of these or other interfaces may be used. When the user elects to annotate a page or site, user annotation module 164 receives the new annotation data from the user (e.g., via client system 120) and updates personalization database 166.

Query response module 162 in one embodiment references various page indexes 170 that are populated with, e.g., pages, links to pages, data representing the content of indexed pages, etc. Page indexes may be generated by various collection technologies including an automatic web crawler 172, and/or various spiders, etc., as well as manual or semi-automatic classification algorithms and interfaces for classifying and ranking web pages within a hierarchical structure. These technologies may be implemented in search server system 160 or in a separate system (e.g., web crawler 172) that generates a page index 170 and makes it available to search server system 160. Various page index implementations and formats are known in the art and may be used for page index 170.

Query response module 162 is configured to provide data responsive to various search requests (queries) received from a client system 120, in particular from search module 126. As used herein, the term “query” encompasses any request from a user (e.g., via client 120) to search server 160 that can be satisfied by searching the Web (or other corpus) indexed by page index 170. In one embodiment, a user is presented with a search interface via search module 126. The interface may include a text box into which a user may enter a query (e.g., by typing), check boxes and/or radio buttons for selecting from predefined queries, a directory or other structure enabling the user to limit search to a predefined subset of the full search corpus (e.g., to certain web sites or a categorical subsection within page index 170), etc. Any search interface may be used.

Query response module 162 is advantageously configured with search related algorithms for processing and ranking web pages relative to a given query (e.g., based on a combination of logical relevance, as measured by patterns of occurrence of search terms extracted from the query; context identifiers associated with search terms and/or particular pages or sites; page sponsorship; connectivity data collected from multiple pages, etc.). For example, query response module 162 may parse a received query to extract one or more search terms, then access page index 170 using the search terms, thereby generating a list of “hits”, i.e., pages or sites (or references to pages or sites) that are determined to have at least some relevance to the query. Query response module 162 may then rank the hits using one or more ranking algorithms. Particular algorithms for identifying and ranking hits are not critical to the present invention, and conventional algorithms may be used.

In some embodiments of the present invention, query response module 162 is also configured to retrieve from personalization database 166 any annotation data associated with any user belonging to the querying user's trust network (including the querying user) and to incorporate such annotation data into the search results. Retrieval of annotation data may involve interaction between query response module 162 and trust network module 165, e.g., to obtain a list of trust network members, and/or between query response module 162 and annotation module 164, e.g., to retrieve the annotation data once the trust network members are identified. Incorporation of annotation data can be done in a variety of ways, examples of which are described in above referenced application Ser. No. 11/081,860 and application Ser. No. 11/082,202.

To enable personalization features such as trust network annotations, access to a personalized portal and/or keyword subscription management, search server 160 advantageously provides a user login feature, where “login” refers generally to any procedure for identifying and/or authenticating a user of a computer system. Numerous examples are known in the art and may be used in connection with embodiments of the present invention. For instance, in one embodiment, each user has a unique user identifier (ID) and a password, and search server 160 prompts a user to log in by delivering to client 120 a login page via which the user can enter this information. In other embodiments, biometric, voice, or other identification and authentication techniques may also be used in addition to or instead of a user ID and password.

Once the user has identified herself, e.g., by logging in, the user can create and/or update annotations by interacting with user annotation module 164; the user can also define and/or modify keyword subscriptions by interacting with subscription module 168 as described below. Further, each query entered by a logged-in user can be associated with the unique user ID for that user; based on the user ID, query response module 162 can access personalization database 166 to incorporate annotations ITom members of the querying user's trust network into responses to that user's queries. User login is advantageously persistent, in the sense that once the user has logged in (e.g., via client application 125), the user's identity can be communicated to search server 160 at any appropriate time while the user operates client application 125. Thus, personalization features described herein can be made continuously accessible to a user.

In accordance with an embodiment of the present invention, search server 160 also includes subscription module 168, via which a first user (“subscribing user”) can subscribe to receive updates when another user (“annotating user”) annotates a page. In some embodiments, the subscribing user specifies a keyword or label of interest and is notified when the annotating user creates an annotation containing that keyword or label. The user may identify annotating users specifically (e.g., by user ID) or by description (e.g., members of the user's trust network out to some maximum degree of separation, members of a network-based discussion group to which the user belongs, or the like). Subscription module 168 advantageously provides an interface via which the user defines subscriptions and back-end functionality by which subscriptions are serviced.

For example, in one embodiment, subscriptions are serviced by creating RSS (Really Simple Syndication) feeds that can be added to a user's RSS aggregator service. When a user subscribes to a keyword, subscription module 168 creates an RSS feed file (typically an XML file) representing the feed and inserts a URL for the RSS file into the code defining the user's RSS aggregator. Alternatively, subscription module 168 can provide the URL or other reference to the RSS file to the user, who can insert it into an RSS aggregator of his or her choice. Subscription module 168 also creates a script to update the content of the RSS file when new annotations the RSS file when new annotations meeting the user's conditions are created. In some embodiments, subscription module 168 provides the script for each subscription to annotation module 164, and annotation module 164 executes the script for each annotation it receives, either in real time or at regular intervals (e.g., hourly or daily).

It will be appreciated that the search system described herein is illustrative and that variations and modifications are possible. The content server and search server system may be part of a single organization, e.g., a distributed server system such as that provided to users by Yahoo! Inc., or they may be part of disparate organizations. Each server system generally includes at least one server and an associated database system, and may include multiple servers and associated database systems, and although shown as a single block, may be geographically distributed. For example, all servers of a search server system may be located in close proximity to one another (e.g., in a server farm located in a single building or campus), or they may be distributed at locations remote from one another (e.g., one or more servers located in city A and one or more servers located in city B). Thus, as used herein, a “server system” typically includes one or more logically and/or physically connected servers distributed locally or across one or more geographic locations; the terms “server” and “server system” are used interchangeably. In addition, the query response module and user annotation module described herein may be implemented on the same server or on different servers.

The search server system may be configured with one or more page indexes and algorithms for accessing the page index(es) and providing search results to users in response to search queries received from client systems. The server system might generate the page indexes itself, receive page indexes from another source (e.g., a separate server system), or receive page indexes from another source and perform further processing thereof (e.g., addition or updating of various page information). In addition, while the search server system is described as including a particular combination of component modules, it is to be understood that a division into modules is purely for convenience of description; more, fewer, or different modules might be defined.

In addition, in some embodiments, some modules and/or metadata described herein as being maintained by search server 160 might be wholly or partially resident on a client system. For example, some or all of a user's annotations could be stored locally on client system 120 and managed by a component module of client application 125. Other data, including portions or all of page index 170, could be periodically downloaded from search server 160 and stored by client system 120 for subsequent use. Further, client application 125 may create and manage an index of content stored locally on client 120 and may also provide a capability for searching locally stored content, incorporate search results including locally stored content into Web search results, and so on. Thus, search operations may include any combination of operations by a search server system and/or a client system.

### II. SUBSCRIBING TO TAGS

In accordance with an embodiment of the present invention, a content annotation service allows a user to subscribe to a keyword. As used herein, “subscribe to a keyword” refers to a user making a standing request to be notified when a content item is annotated with a particular keyword. As used herein, “keyword” (also sometimes referred to in the art as a “tag”) refers to a word or short phrase provided by the user; in some embodiments, the user is free to choose any word or phrase; in other embodiments, the user selects a word or short phrase (“label”) from a system-defined vocabulary, such as a hierarchical list of category identifiers. Whether a particular annotation system employs freely chosen keywords or system-defined labels is not critical to the present invention, and “keyword” as used herein should be understood as subsuming both cases. As used herein, “tagging” a content item refers generally to the act of associating with the content item a keyword or label. In some embodiments, users tag content items when they create annotations.

In some embodiments, the subscription service exploits a conventional content syndication technology such as RSS (Rich Site Summary, also sometimes called Really Simple Syndication and RDF (resource description Site Summary). As is known in the art, an RSS feed for a Web site is generally an XML file that is stored on the originating site's Web server. The RSS feed includes a structured summary of the site's current and/or recent content; a typical RSS feed includes a number of “headlines” having various segments such as a title, a link to the content, and a brief description. The RSS feed can be created and updated manually (e.g., by editing the XML) or automatically (e.g., by using various scripts to periodically scan the site and update the XML). Operators of other sites, or individual users, can “subscribe” a page to the RSS feed by including a reference to the desired RSS feed in the HTML or other source code for the subscribed page. When the subscribed page is displayed, the RSS feed (which is maintained on the originating site's server) is accessed, and the title of each item in the summary (along with other information if desired) is displayed on the subscribed page as a link. A viewer of the subscribing page can click on any of these links to view the item at the originating site.

Embodiments of the present invention exploit RSS technology to provide a service via which a user of a multi-user annotation system can subscribe to a keyword. In one embodiment, a keyword subscription service can be implemented by: (1) providing an interface via which a user can define subscriptions to keywords; (2) creating an RSS feed corresponding to each subscription; (3) updating the RSS feed as new annotations are received; and (4) delivering the RSS feed to the user.

A. Subscription Interface

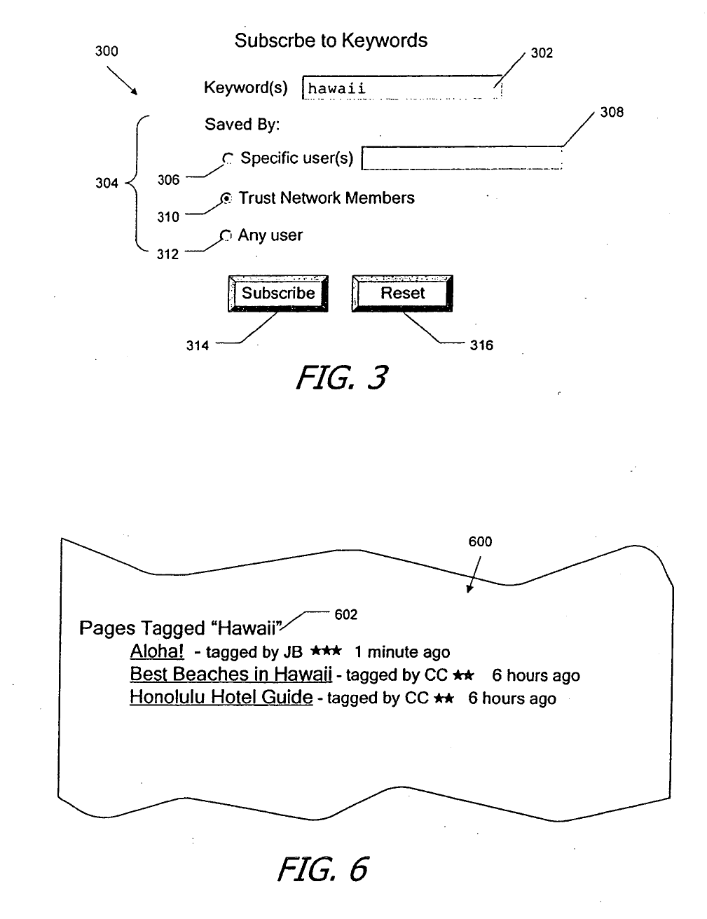

FIG. 3 illustrates an interface page 300 via which a user can define subscriptions to content. Page 300 may be accessed, e.g., via a link from a “My Web” interface page (e.g., as described in above-referenced application Ser. No. 11/082,202), from a home page of a multi-user annotation service, from a toolbar button in a Web browser, or the like.

Interface page 300 is designed for subscribing to keywords. The user enters the desired keyword (or keywords) in a text box 302. In some embodiments, the user can define multiple keywords and connect them using Boolean operators. For instance, the user could enter “hawaii OR oahu” in box 302 to be notified when a page is tagged with either keyword. Similarly, the user could enter “hawaii AND surfing” in box 302 to be notified only when a page is tagged with both keywords.

In section 304, the subscribing user can limit the subscription to specific tagging users (also referred to herein as annotating users). For instance, the user can identify specific tagging users by selecting radio button 306 and entering one or more user IDs of other users in text box 308. The subscribing user can limit the notification to members of his or her trust network by selecting radio button 310. The subscribing user can also elect to be notified when any user tags a content item with the keyword(s) in box 302 by selecting radio button 312. Activating “Subscribe” button 314 submits the subscription request to annotation server 160, and activating “Cancel” button 316 resets page 300.

It will be appreciated that page 300 is illustrative and that variations and modifications are possible. Other interfaces may be substituted, and other options may be provided. For instance, in some embodiments, the user may be able to limit the subscription, e.g., by excluding pages based on domain or particular content, by specifying tagging users and/or keywords to exclude, and so on. Where a user subscribes to tags by his or her trust network members, the subscribing user might also be able to specify a maximum degree of separation in the trust network, a minimum trust weight, or the like. In embodiments where tagging users have reputation scores (e.g., based on feedback from other users evaluating the tagging user's tags), the user might set a threshold on the reputation score of the tagging user.

In still other embodiments, users might also be able to define tagging users by reference to an well-defined groups or communities of users. As used herein, a “community” refers to any ongoing forum for which search server 160 can obtain a list of user IDs of the members and associate those IDs with authors of annotations. Typically (but not necessarily), a community uses at least one network-based communication medium managed by a provider of search server 160, such as a subscription-based e-mail distribution list, a members-only chat room, a bulletin board or the like. In one embodiment, the communities correspond to Yahoo! Groups, but any other online communities whose members' identities can be determined by search server 160 might be used; more generally, any organization or forum that provides a well-defined membership list can be used as a community as long as search server 160 can map the user identifiers in the membership list to user identifiers of participants in the annotation system. The user can, for instance, subscribe to keywords where the annotating user is a member of a particular community; the subscribing user might or might not be a member of the community.

In other embodiments, the subscribing user can identify tagging users their membership in an “implicit community.” An implicit community consists of users known to meet some criterion, regardless of whether they have formally joined a particular online community. Implicit groups can be formed, e.g., demographic criteria, such as “users who live in Sunnyvale, Calif.” or “female users” or “users in the 18-34 age bracket.” Implicit groups might also be formed based on behavioral criteria such as frequent visitors to a particular page or site. Whether a tagging user matches the criteria is determined by user profiles maintained by the provider of search server 160.

B. RSS Feed Creation

Creation of RSS feeds for keyword subscriptions will now be described. In one embodiment, RSS feeds are created by subscription model 168 of FIG. 2 in response to requests received from users.

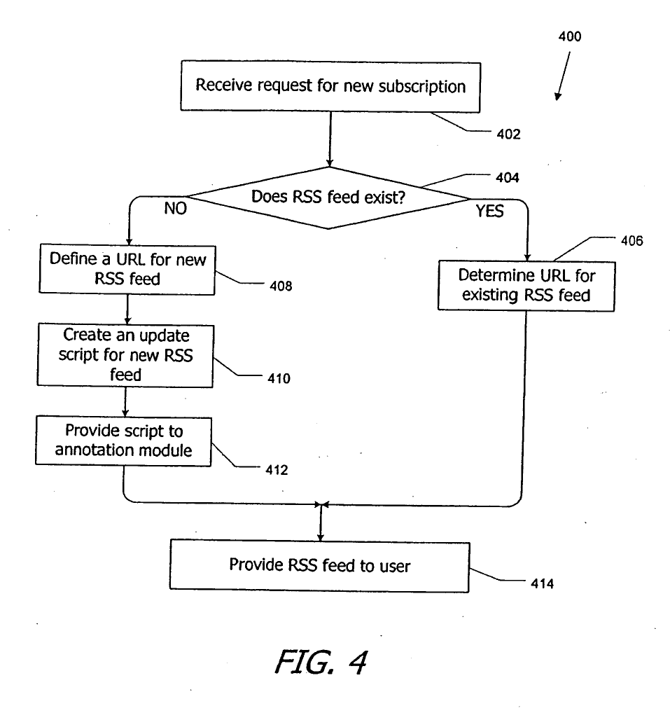

FIG. 4 is a flow diagram of a process 400 for creating an RSS feed corresponding to a subscription according to an embodiment of the present invention; process 400 may be implemented in subscription module 168 of FIG. 2.

At step 402, subscription module 168 receives a request from a user for a new subscription. For instance, the user might submit information using page 300 of FIG. 3 described above; other channels and request formats may be substituted. The request includes the subscription parameters, e.g., the keyword(s) and tagging users specified by the subscribing user, as well as the subscribing user's ID.

At step 404, subscription module 168 determines whether an RSS feed corresponding to the requested subscription already exists. In one embodiment, subscription module 168 maintains a list of defined subscriptions and the parameters (e.g., keywords and tagging users) for each. If the parameters of the requested subscription exactly match an already-defined subscription, then the RSS feed corresponding to that subscription can be reused rather than creating a new subscription. Thus, if an RSS feed corresponding to the request already exists, then at step 406, subscription module 168 determines the URL for that RSS feed.

If an RSS feed does not exist, then subscription module 168 creates one. More specifically, at step 408, subscription module 168 defines a URL for a new RSS feed. In one embodiment, the URL encodes the subscription parameters in such a way that the determination at step 404 can be made by inspecting the URLs of existing feeds. In another embodiment, subscription module 168 maintains a lookup table or other data structure that maps subscription parameters to URLs, and step 408 includes updating the lookup table with the new URL and subscription parameters so that the RSS feed can be detected at step 404. Defining the URL may also include, e.g., creating an XML file or shell for the RSS feed.

At step 410, subscription module 168 generates a script for updating the new RSS feed. In one embodiment, script module 168 creates the script from a template by filling in parameter values based on the search. The script can be any piece of code that, when executed, determines whether an annotation is created by the user(s) specified in the subscription request and also includes the keyword(s) specified in the subscription request. At step 412, subscription module 168 provides the script to annotation module 164 (FIG. 2). Annotation module 164 executes the script from time to time to update the RSS feed, as described below.

At step 414, the RSS feed is provided to the user. In one embodiment, subscription module 168 provides the URL of the RSS feed to the user, and the user can add this feed to any RSS aggregation page or service. In another embodiment, a provider of search server 160 (FIG. 2) also provides a personalized portal page for registered users that includes RSS aggregation, and search server 168 adds the URL of the RSS feed to the RSS aggregator on the subscribing user's personalized portal page. (An example of a personalized portal page that provides RSS aggregation is the My Yahoo! page provided by Yahoo! Inc., assignee of the present application.)

It will be appreciated that the subscription process described herein is illustrative and that variations and modifications are possible. Steps described as sequential may be executed in parallel, order of steps may be varied, and steps may be modified or combined.

C. RSS Feed Updates

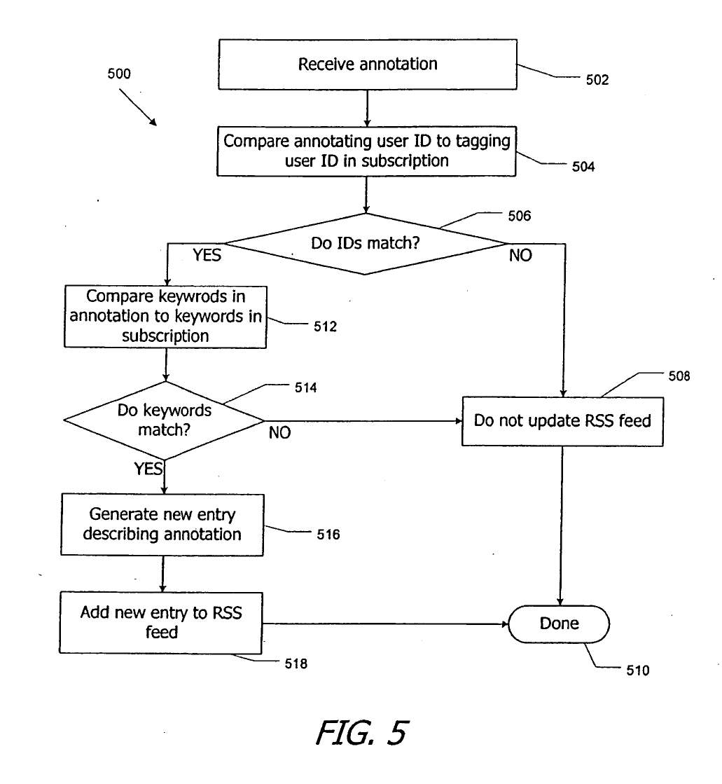

The RSS feeds corresponding to keyword subscriptions are advantageously updated as new annotations are received, e.g., by annotation module 164 of FIG. 2. FIG. 5 is a flow diagram of a process 500 for updating RSS feeds according to an embodiment of the present invention. Process 500 can be executed by annotation module 164 and can be controlled at least in part in part by scripts generated by subscription module 168 as described above. Process 500 can be executed in real time (as annotations are received) or at intervals, e.g., hourly or daily, using a log of recent annotations that can be maintained by annotation module 164.

Referring to FIG. 5, at step 502, annotation module 164 receives an annotation. The annotation advantageously includes a user ID of the annotating user, an identifier (e.g., URL) of the content item being annotated, and annotation information including keywords provided by the annotating user.

At step 504, the ID of the annotating user is compared to the user IDs associated with the subscription, and at step 506, it is determined whether the IDs match. Where the subscription is not restricted to particular annotating users, any user ID is considered a match at step 506. Where the subscription is restricted to one or more specific user IDs, the annotating user ID must match one of the user IDs for a match to be found at step 506.

Where the subscription is restricted to members of a user's trust network, steps 504 and 506 may include retrieving or dynamically building the user's trust network data based on relationship information included in personalization database 166 of FIG. 2. (Dynamic building of trust networks is described, e.g., in above-referenced application Ser. No. 11/082,202.)

Where the subscription is restricted to members of a community, steps 504 and 506 may include comparing the ID of the annotating user to the current list of members of the community. Where the subscription is restricted to members of an implicit community, steps 504 and 506 may include retrieving demographic or other profile data for the annotating user and comparing that data to the subscription criteria defined by the subscribing user.

If matching user IDs are not detected at step 506, then the RSS feed is not updated (step 508), and process 500 completes (step 510). If matching user IDs are detected, then at step 512, keywords in the annotation are compared to keywords associated with the subscription, and at step 514, it is determined whether there is a keyword match. Conventional techniques, including canonicalization (e.g., stemming, changing variant spelling, etc.), removal of stop words and the like may be used for comparing keywords and detecting keywords matches. Where the subscription specifies a Boolean expressil5n, appropriate Boolean logic is applied to the keywords in the annotation.

At step 516, a new entry (e.g., an XML <item> block) for the RSS feed is created. The new entry advantageously describes the annotated page and/or the annotation and may include, e.g., the title of the annotated page, the URL of (or an active link to) the annotated page, the user ID of the annotating user, and the time of the annotation. Other information, such as a reputation score of the annotating user or the like, also be included.

At step 518, the new entry is added to the RSS feed for the keyword subscription. As is known in the art, RSS feeds are generally maintained in reverse chronological order, i.e., with the most recently added item at the top. Accordingly, the new item may be added at the top of the item list. In addition, an old item may be dropped off the bottom of the list if desired. (Dropping old items is not required but can prevent RSS feed files from becoming long enough to significantly delay page loading when the user is viewing the RSS feed.) Thereafter, process 500 completes (step 510).

It will be appreciated that the process described herein is illustrative and that variations and modifications are possible. Steps described as sequential may be executed in parallel, order of steps may be varied, and steps may be modified or combined. For instance, the keyword comparison can precede the user-ID comparison, or both comparisons can be performed in parallel. Fast algorithms for detecting matches can be used.

D. Delivery of RSS Feeds

The subscribing user can view his or her keyword subscriptions via an RSS aggregator, e-mail service, or the like, which maybe of generally conventional design. In one embodiment, the subscribing user is provided with the URL for the RSS feed of the keyword subscription and can choose any avenue for viewing it. In another embodiment, the RSS feed is automatically added to a personal portal or RSS aggregator page maintained for the user by the provider of search server 160 as described above.

FIG. 6 illustrates an RSS feed 600 for a keyword subscription as viewed by a user according to an embodiment of the present invention. The RSS feed is advantageously titled (at 602) using the keyword(s) specified in the subscription request so that the user can recognize the subscription.

Each entry includes a page title (e.g., Aloha!), a user ID of the tagging user (e.g., JB), a star rating for the tagging user (e.g., based on reputation score), and an age indicator for the annotation (e.g., 1 minute ago).

The entry advantageously provides links to additional information. For instance, the entry can link to the annotated page, to the annotation, to a page created by or about the annotating user, or the like. Feed 600 advantageously appears in the user's RSS aggregator or other RSS-based notification service.

It will be appreciated that the RSS feed described herein is illustrative and that variations and modifications are possible. A user may have any number of subscriptions, and a separate feed is advantageously provided for each subscription. Any number of entries can be displayed.

### III. FURTHER EMBODIMENTS

While the invention has been described with respect to specific embodiments, one skilled in the art will recognize that numerous modifications are possible. For instance, the appearance of various reports and user interfaces may differ from the examples shown herein. Interface elements are not limited to buttons, clickable regions of a page, text boxes, or other specific elements described herein; any interface implementation may be used. Annotations can include any number of fields in any combination and may include more fields, fewer fields, or different fields from those described herein.

The invention is also not limited to keywords in a “keywords” field of an annotation. In some embodiments, where the annotation includes a free-text description, the description provided by the annotating user can be treated as a source of keywords. In other embodiments, where annotating users label pages using labels selected from a predefined vocabulary, a user may subscribe to labels in addition to or instead of keywords. Where keywords, free text descriptions, and labels are all present, the user may select which of these field(s) to include in the subscription.

In still other embodiments, the user might subscribe to all annotations by a particular user (regardless of keywords) or to all annotations pertaining to a particular content item (regardless of the annotating user or keywords) or to any other metadata associated with user annotation or tagging of content items.

Further, while RSS is used in embodiments herein as an example of a mechanism for servicing subscriptions to keywords, it is to be understood that other notification mechanisms could also be used, such as e-mail alerts, instant messages, or the like: More generally, any form of electronic communication that can be automatically initiated upon detecting an annotation that matches the subscription parameters defined by the user may be used. The embodiments described herein may make reference to Web sites, URLs, links, and other terminology specific to instances where the World Wide Web or a subset thereof) serves as the search corpus. It should be understood, however, that the systems and methods described herein can be adapted for use with a different search corpus (such as an electronics database or document repository) and that search reports or annotations may include content as well as links or references to locations where content may be found.

Computer programs incorporating various features of the present invention may be encoded on various computer readable media for storage and/or transmission; suitable media include magnetic disk or tape, optical storage media such as CD or DVD, flash memory, and carrier signals adapted for transmission via wired, optical, and/or wireless networks conforming to a variety of protocols, including the Internet. Computer readable media encoded with the program code may be packaged with a compatible device or provided separately from other devices (e.g., via Internet download).

While the present invention has been described with reference to specific hardware and software components, those skilled in the art will appreciate that different combinations of hardware and/or software components may also be used, and that particular operations described as being implemented in hardware might also be implemented in software or vice versa.

Thus, although the invention has been described with respect to specific embodiments, it will be appreciated that the invention is intended to cover all modifications and equivalents within the scope of the following claims.

1. A method for providing access to a content item through the use of a distribution resource, the method comprising:
identifying a subscription keyword in response to an indication by a first user;
generating a distribution resource that corresponds to the subscription keyword;
updating the distribution resource in the event that an annotating user tags a content item with the subscription keyword; and
providing the user with access to the distribution resource.

2. The method of claim 1 wherein generating the distribution resource comprises identifying a given annotating user.

3. The method of claim 2 wherein the distribution resource is updated in the event that the given annotating user is identified by the distribution resource.

4. The method of claim 3 wherein the annotating user is explicitly identified by the distribution resource.

5. The method of claim 3 wherein the annotating user is identified as being part of a trust network identified by the distribution resource.

6. The method of claim 5 comprising generating the trust network in real-time for identification by the distribution resource.

7. The method of claim 3 wherein the annotating user is identified as being part of a common community identified by the distribution resource.

8. The method of claim 1 wherein providing the user with access comprises proving a link to the tagged content item.

9. The method of claim 1 wherein providing the user with access comprises providing the tagged content item to the user.

10. The method of claim 1 wherein generating comprises generating when the distribution resource does not correspond to the subscription keyword.

11. The method of claim 1 wherein generating comprises subscribing to the distribution resource where the distribution resource exists and corresponds to the subscription keyword.

12. The method of claim 1 wherein generating comprises creating a link to the distribution resource.

13. (canceled)

14. The method of claim 1 wherein generating the distribution resource comprises generating a data feed.

15. (canceled)

16. (canceled)

17. Computer readable media comprising program code for execution by a programmable processor to cause the processor to execute a method for providing access to a content item through the use of a distribution resource, the computer readable media comprising:
program code for identifying a subscription keyword in response to an indication by a first user;
program code for generating a distribution resource that corresponds to the subscription keyword;
program code for updating the distribution resource in the event that an annotating user tags a content item with the subscription keyword; and
program code for providing the user with access to the distribution resource.

18. The method of claim 17 wherein program code for generating the distribution resource comprises program code for identifying a given annotating user.

19. The method of claim 18 wherein the distribution resource is updated in the event that the given annotating user is identified by the distribution resource.

20. The method of claim 19 wherein the annotating user is explicitly identified by the distribution resource.

21. The method of claim 19 wherein the annotating user is identified as being part of a trust network identified by the distribution resource.

22. The method of claim 21 comprising program code for generating the trust network in real-time for identification by the distribution resource.

23. The method of claim 19 wherein the annotating user is identified as being part of a common community identified by the distribution resource.

24. The method of claim 17 wherein program code for providing the user with access comprises program code for proving a link to the tagged content item.

25. The method of claim 17 wherein program code for providing the user with access comprises program code for providing the tagged content item to the user.

26. The method of claim 17 wherein program code for generating comprises program code for generating when the distribution resource does not correspond to the subscription keyword.

27. The method of claim 17 wherein program code for generating comprises program code for subscribing to the distribution resource where the distribution resource exists and corresponds to the subscription keyword.

28. The method of claim 17 wherein program code for generating comprises program code for creating a link to the distribution resource.

29. (canceled)

30. (canceled)

31. (canceled)

32. (canceled)
